(19) United States
(12) Patent Application Publication
(10) Pub. No.: US 2014/0316946 A1
(43) Pub. Date: Oct. 23, 2014

(54) EVENT-DRIVEN SALES PLATFORM AND NOTIFICATION SYSTEM AND METHOD

(71) Applicants: Christine M. Sanders, Kansas City, MO (US); Janice Harris, Independence, MO (US)

(72) Inventors: Christine M. Sanders, Kansas City, MO (US); Janice Harris, Independence, MO (US)

(21) Appl. No.: 14/260,003

(22) Filed: Apr. 23, 2014

Related U.S. Application Data
(60) Provisional application No. 61/814,975, filed on Apr. 23, 2013.

(51) Int. Cl. G06Q 30/06

(52) U.S. Cl. CPC G06Q 30/0625; G06Q 30/0633
USPC 705/26.62

(57) ABSTRACT

An online marketplace where second-hand sellers can attract and notify buyers of their inventory. An item can be added to the market place by a seller using the seller's computer. Alternatively, the seller can advertise a sale of multiple items using the online marketplace. A buyer can browse items and sales using the buyer's computer, can choose to add items to wish lists or watch lists, and can purchase items directly from the online marketplace. Alerts are sent to the user when items added to the watch lists or wish lists are altered to change quantity, quality, or price information.

### CROSS-REFERENCE TO RELATED APPLICATION

This application claims priority in U.S. Provisional Patent Application No. 61/814,975, filed Apr. 23, 2013, which is incorporated herein by reference.

### BACKGROUND OF THE INVENTION

1. Field of the Invention

The present invention relates generally to an online marketplace for second-hand goods, and more specifically to a digital marketplace accessible by buyers and sellers on mobile computing devices which brings buyers and sellers together based on geographic sales and sales of particular second-hand items.

2. Description of the Related Art

Online marketplaces for the direct consumer exchange of goods have been in existence for several years now and there is significant continued demand for these types of platforms. Consumers exchange goods directly for various reasons, including but not limited to: selling new or used goods for money, giving goods away to others in need, and general exchange per a bartering relationship. Most typically, these exchange platforms are functionally similar to how a bulletin board has worked in past decades, as the seller of the goods posts what he/she has for sale either with a direct list price or an opportunity for the buyer to make an offer to the seller directly. In some current online market applications there are also auction or reverse auction capabilities, offering updates to the typical users.

Second-hand sales such as those that take place at garage/yard sales, thrift stores, and vintage-merchandise shops are a popular and common means for individuals to make money on previously used items. Most often these sales contain limited merchandise and there is often no way for buyers to determine what items may be available at such a sale without personally browsing the entire selection. This also requires the buyer to know about the sale and to travel to the sale location.

These sales and stores are also generally too small to warrant their own online retail presence. The sales term is generally limited, and items and inventory are constantly changing as inventory moves through the store or sale. There is also generally no easy way for potential buyers to keep track of items found at such shops or sales without personally contacting the seller.

What is needed is a system which provides an online marketplace for second hand merchandise and/or small inventory sellers who would otherwise not have the means or the need for an online presence. The system should also provide a way for buyers to search for specific items and locate those individuals who are selling similar items.

Heretofore there has not been available an event-driven sales platform with the features and elements of the present invention.

### SUMMARY OF THE INVENTION

The present invention provides an online marketplace where second-hand sellers can attract and notify buyers of their inventory. The typical situation where the present invention would be used is in the case of an event-driven sale, such as a yard sale or a garage sale. However, the present invention would likely find use in permanent retail stores having inventory with a high turnover rate, such as thrift shops or vintage-merchandise stores.

The present invention generally involves an online marketplace which may be accessed by a seller. The seller can put up the location of her sale on the website so that the sale can be searched and found by buyers. The sale's location can be tracked using a mapping function which provides step-by-step driving directions to a buyer.

The seller may also populate her sale's online information with a list of merchandise available at the sale. The list of merchandise may include photographs of the pieces of merchandise, as well as pricing and brief descriptions of the items for sale, such as the quality of those items and how much they have been used.

Buyers searching for items can mark items to place them on a “wish list.” Those buyers who mark an item are placed on a list of subscribers. If details about an item are changed, such as a price drop or the item is purchased, all subscribers will be notified.

The present invention may also be used for single-item sales.

### BRIEF DESCRIPTION OF THE DRAWINGS

The drawings constitute a part of this specification and include exemplary embodiments of the present invention illustrating various objects and features thereof

FIG. 1 is a box diagram demonstrating the relationship between several elements employed in an embodiment of the present invention.

FIG. 2 is a flowchart demonstrating the steps necessary to practicing a method employed in an embodiment of the present invention.

FIG. 3 is a flowchart demonstrating the steps necessary to practicing another method employed in an embodiment of the present invention.

FIG. 4A is a diagrammatic representation of a user interface as it would appear on a mobile computing device.

FIG. 4B is an alternative diagrammatic representation of a user interface as it would appear on a mobile computing device.

FIG. 4C is an alternative diagrammatic representation of a user interface as it would appear on a mobile computing device.

FIG. 4D is an alternative diagrammatic representation of a user interface as it would appear on a mobile computing device of a buyer.

FIG. 4E is an alternative diagrammatic representation of a user interface as it would appear on a mobile computing device of a seller.

### DETAILED DESCRIPTION OF THE PREFERRED EMBODIMENTS

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, a mobile smart device including a display device for viewing a typical web browser or user interface will be commonly referred to throughout the following description. The type of device, computer, display, or user interface may vary when practicing an embodiment of the present invention. Other terminology relating to event-driven sales, such as garage or yard sales or other temporary sales events, may be used. Such terminology should be interpreted as applying to any and all event-driven sales types. Said terminology will include the words specifically mentioned, derivatives thereof and words of similar meaning.

II. Event-Driven Sales System 2

The present invention presents an event-driven sales system 2 which primarily takes place on a communications network 10. This network generally incorporates the World Wide Web (a.k.a. “Internet”) which is accessible using mobile wireless devices (e.g., “smart phones” or “smart devices”).

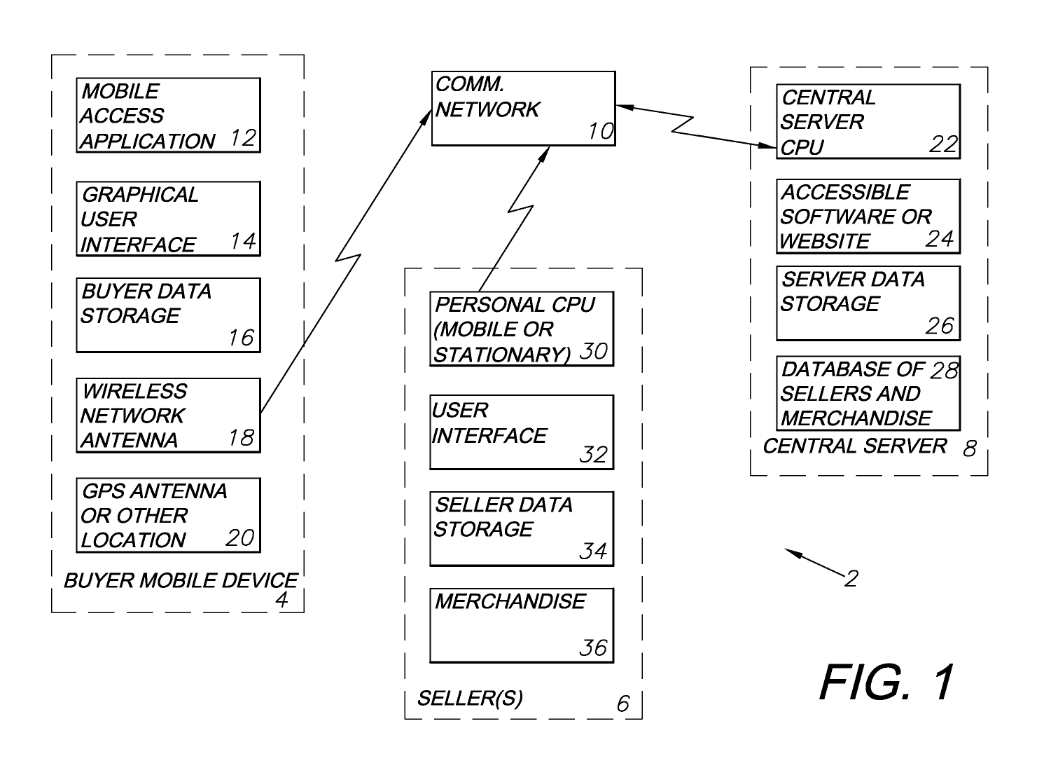

As shown in FIG. 1, a central server 8 houses a central server CPU 22. This CPU 22 hosts accessible software or a website 24 which provides the backbone to the sales system 2. This website and/or software 24 provides the interface and details necessary for a seller and a buyer to interact over the network 10. The server CPU 22 also houses a server data storage device 26 which contains the software 24 and a database of items 28 being sold by sellers 6.

The seller(s) 6 use a personal computing device 30 with a CPU to access the website/software 24 housed on the server 8. The seller's personal computing device 30 may be a personal computer (“PC”), a mobile smart device, or any other device capable of accessing the website 24 and providing feedback capable of updating the website. The seller's computing device 30 includes a user interface 32 and data storage 34. The user interface 32 allows the seller to interact with the website 24 hosted on the server 8. The data storage 34 contains locally stored information, such as pictures and text describing merchandise 36 being sold by the seller 6.

A buyer accesses the website 24 using a mobile device 4 or, alternatively, a personal computing device. The mobile device would host a mobile access application 12, whereas a standard personal computing device would access the website 24 directly. The mobile access application 12 includes a graphical user interface 14 which allows the buyer to easily browse merchandise stored in the database 28.

The mobile device will likely contain a data storage element 16 which may contain details about the buyer or other pertinent data necessary for transactions between the buyer, the seller, and the central server 8. The mobile device 4 would connect to the network 10 wirelessly using a wireless network antenna 18 or other means. The mobile device may also include a GPS antenna 20 or other means of pinpointing the location of the buyer's mobile device 4. This allows the sales system 2 to locate sales and sellers within the buyer's general vicinity.

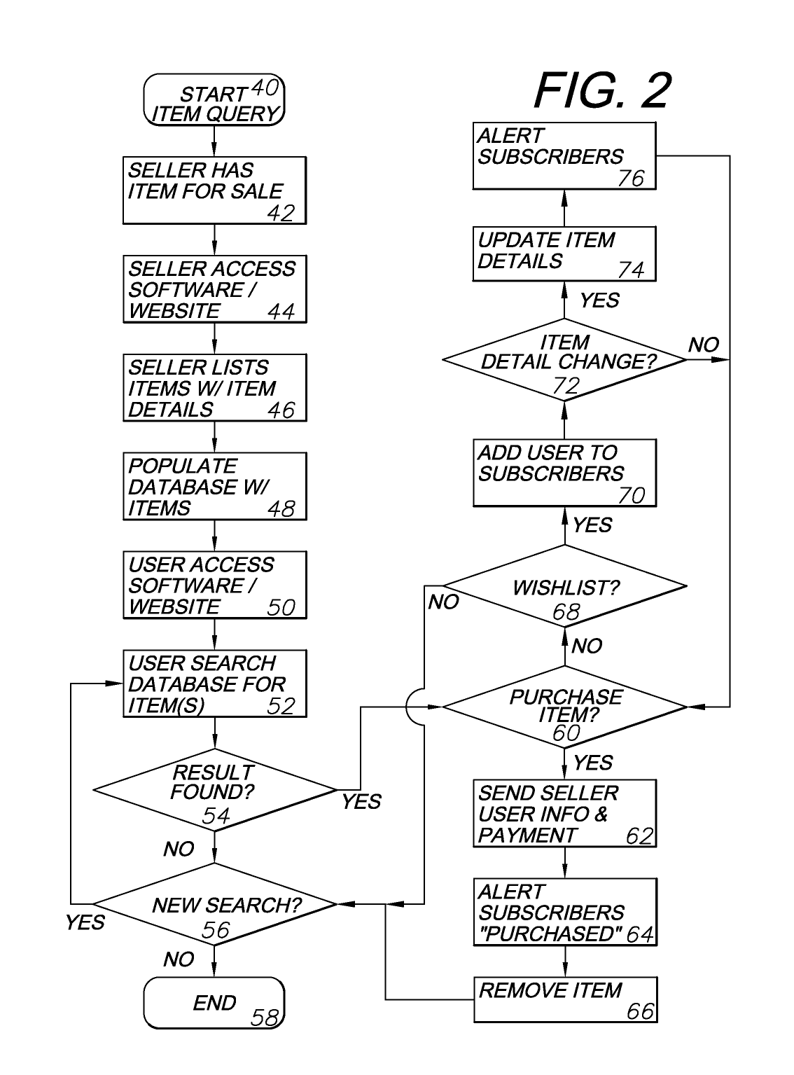

FIG. 2 presents a flowchart demonstrating the steps of a buyer searching for a particular item using the sales system 2. The process begins at 40. The seller has an item for sale at 42 and accesses the website 24 at 44. This process requires the seller to put in basic information about the item at 46. The seller may also add more than one item at a time.

The details about the item may include a photograph of the item, a brief textual description of the item, and information about the item's quality. The information must also include a sales price.

The system will populate the database of merchandise 36 with all of the seller's items for sale at 48. At this time a buyer may access the website at 50 and search for a particular item at 52. If no result is found at 54, the buyer will have the option of performing a new search at 56. If the buyer elects to perform a new search, the search begins again at 52. Otherwise the process ends at 58.

It should be noted that search results may be organized based upon the buyer's location at the time the search is made. The radius of search results focuses on either the address information manually entered by the buyer or upon global navigation satellite system data received by the radio receiver in the buyer's mobile device.

If a result is found at 54 the item is shown to the buyer along with similar alternatives. The option to purchase an item is presented to the buyer at 60. If the buyer purchases the item, the buyer's information is sent to the seller at 62. This step includes the buyer's preferred purchasing method (e.g., credit card, direct withdrawal from a bank account, cash on pick-up, etc.). The seller may also be provided the buyer's address if the preferred method of delivery is via courier or standard mail.

Users who had previously added that item to their wish list are notified by alert that the item has been purchased at 64. The item is then removed from the database at 66 and the buyer is prompted to begin a new search or quit at 56.

If instead the buyer decides not to purchase the item at 60, the buyer will be prompted to add the item to his wish list at 68. If the buyer decides not to do this, the buyer will be prompted to begin a new search or quit at 56.

If the buyer decides to add the item to his wish list at 68, the buyer will be added to a list of subscribers to that item at 70. This means that any changes to that particular item will result in a notification being sent to that user and all other subscribed users. The system 2 may optionally also notify the buyer of similar items. It should be noted that two options could be available here. A wish list would be shared amongst other users who had permission to view the buyer's wish list and to see items placed on that list. Alternatively, a simple watch list could be used which would be private to the user who created the list.

The system 2 will monitor items in the database 28 to determine whether the details of any item changes at 72. If this never occurs, the buyer still has the option to purchase the item at 60. If the details of an item do change at 72, the item status is updated at 74 and all subscribed users are notified at 76. This will again prompt the user to determine whether or not to purchase the item at 60. This loop continues until the item is purchased or otherwise removed.

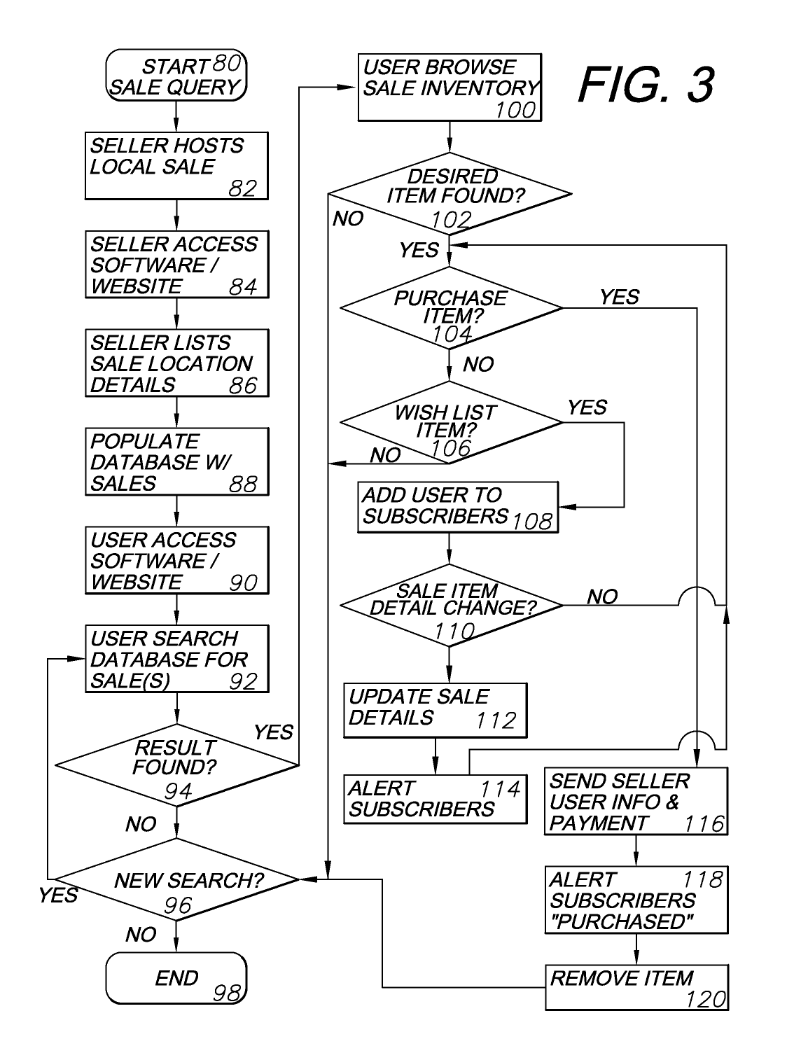

FIG. 3 demonstrates a similar method where a seller lists her actual event-driven sales event rather than a single item. The process is slightly different in this case.

This process starts at 80. A seller hosts their local sale at 82, such as a garage sale, a yard sale, or any new inventory at a permanent location. The seller then accesses the website 24 for the sales system 2 at 84. The seller will list their sale at 86, including details about the sale such as location, operating hours, and types of merchandise for sale. The seller may also list her merchandise for sale, similar to the process shown in FIG. 2. The database 28 is the populated with all such sales at 88 and all items that sellers choose to identify.

The user will access the website at 90 and search for local sales at 92. This search may have variables to narrow down the results, if any. The search may include a description of merchandise that the buyer is looking for, a maximum distance of travel from the buyer's present location as determined using the position of the buyer's mobile device 4, or other pertinent information.

If no results are found at 94, the user will be prompted whether he would like to begin a new search at 96. If the user decides to narrow his search or begin an entirely new search, the user will return to step 92. Otherwise the process will end at 98.

If results of sales are found, the user may be prompted to browse the sale inventory at 100. Alternatively, the user will now know the location(s) of the local sale(s) and may choose to travel to the sale site to browse merchandise in person.

The user will browse the sales inventory using the user interface. If no desired items are found at 102, the buyer can begin a new search at 96 or stop the process at 98.

If a desired item is found, the buyer will be prompted to purchase the item at 104 or add the item to a wish list at 106, similar to the process shown in FIG. 2. If neither option is chosen, the buyer can begin a new search at 96 or stop the process at 98.

If the buyer opts to purchase the item straight away at 104, the buyer's information is sent to the seller at 116, users who had previously added that item to their wish list are notified by alert that the item has been purchased at 118, and the item is then removed from the database at 120. The buyer can begin a new search at 96 or stop the process at 98.

If instead the buyer decides not to purchase the item at 104, the buyer will be prompted to add the item to his wish list at 106. If the buyer decides not to do this, the buyer can begin a new search at 96 or stop the process at 98.

If the buyer decides to add the item to his wish list at 106, the buyer will be added to a list of subscribers to that item at 108. This means that any changes to that particular item will result in a notification being sent to that user and all other subscribed users. The system 2 may optionally also notify the user of similar items.

The system 2 will monitor items in the database 28 to determine whether the details of any item or any sale location changes at 110. If this never occurs, the user still has the option to purchase the item at 104. If the details of an item or sale do change at 110, the item status is updated at 112 and all subscribed users are notified at 114. This will again prompt the buyer to determine whether or not to purchase the item at 104. This loop continues until the item is purchased or otherwise removed.

Items added to a buyer's wish list or watch list can be set such that the user is notified when changes occur to that item. These changes may include a decrease or increase in price, a change in quantity, or the sale of that particular item. The user may opt to be notified by text message to their mobile phone, by email, or by any other conceivable manner of receiving a message.

The seller has the option of printing QR codes or bar codes for their inventory and applying those codes to their inventory products. They can then scan the QR code or take a photo of the code with a mobile device capable of reading the code. The sale system 2 can automatically update the seller's inventory when a QR code is scanned. The system will request pricing information and quantity information once the QR code is scanned.

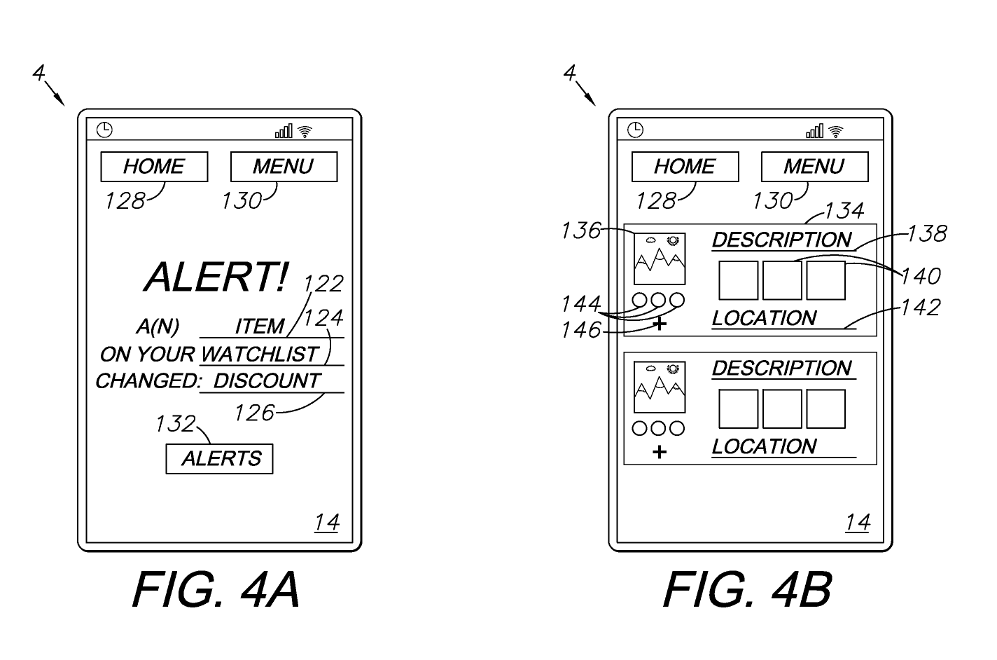

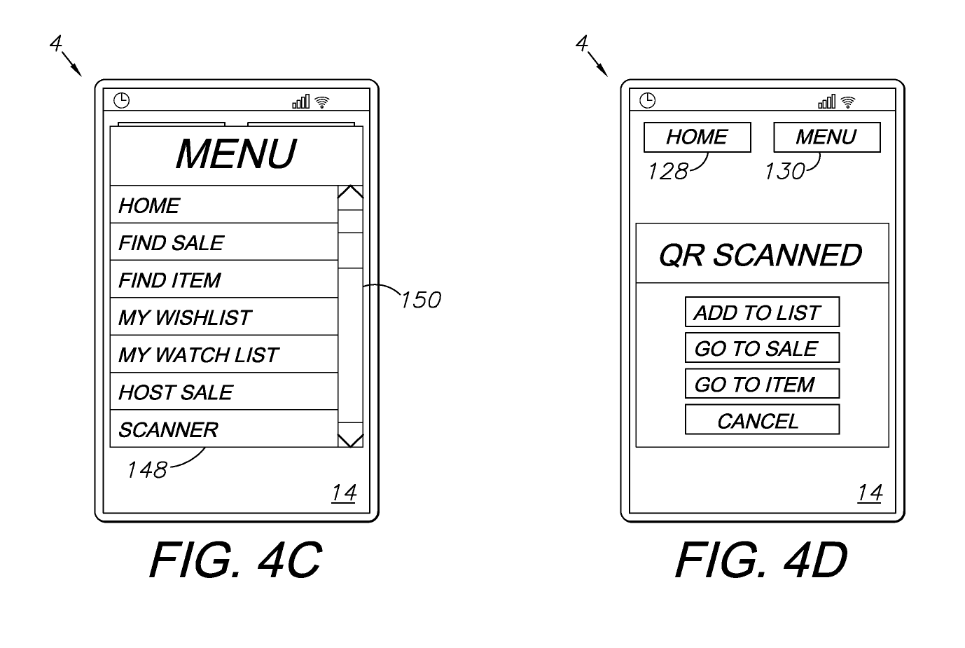

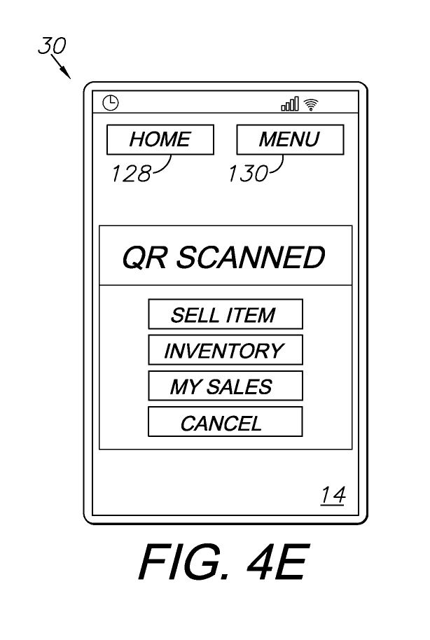

FIG. 4A shows a diagrammatic representation of the user interface 14 of a buyer's mobile computing device 4 when an alert notification is received by the user. The alert message may be sent through the software application or via an email, SMS, or other message type. The alert provides quick information to the user, such as an alert descriptor 122, what list 124 is affected by the alert which prompts this alert to have been sent, and an alert type 126. The alert type notifies the user that the price of the item being watched has dropped, gone up, or if the item is no longer available. Alerts may also be sent to the user if comparable items have been added to the database through other sales or sellers.

The alert page provides at least three quick links that can be accessed by the user. The user can choose the home link 128 which launches the mobile application software 12 on the mobile computer device 4 and takes the user to the home page of that application. The user can choose the menu link 130, which pulls up a menu overlay 148 as shown in FIG. 4C, from which the user can access multiple preferences. Finally, the user can choose the alert link 132, which takes the user to the item, sale, or other location which prompted the alert to be sent. The user can then update his or her preferences. As an example, if the alert type 126 indicates a discount of a single item, the user can activate the alert link 132 and the item's status page will be pulled up. The user can then choose to remove that item from the watch list or choose to purchase the item immediately.

FIG. 4B provides a diagrammatic representation of the user interface 14 when item or sale information has been requested via the mobile application software 12. As show here, each item or sale is isolated into an event box 134 which is selectable by the user and will take the user to a screen with additional information about that item, and possibly the opportunity to purchase the item immediately. The event box 134 also includes an image preview 136 of the item for sale, a brief description 138 of the item, dates 140 of the item's sale or availability. Alternatively, the dates 140 could correspond with a yard sale or other sales event in which the item 136 will be available for purchase. The location 142 of the item and/or sale is also included. Various labels 144 are also located in the event box. These labels provide quick information to the user, such as the number in stock, the rarity of the item, and any special deals associated with the item. Finally, an add/remove 146 option will add or remove the item and/or sale to the user's wish list or watch list as desired.

As stated above, FIG. 4C shows a diagrammatic representation of the menu overlay 148 which appears on the user interface 14 display screen when the menu selection 130 is chosen. The menu overlay could be a completely new screen that is accessed via the software, or it could simply be an overlay that is temporarily placed over the previous access screen until a selection on the menu is made. The menu overlay 148 shown in FIG. 4C features a scrollbar 150 which allows the user to scroll through options in the menu and choose the appropriate next step. Here, the user could first find a sale, and then choose to host their own sale.

As stated previously, the user's mobile device 4, along with the seller's computing device 30, includes a camera capable of scanning a quick response (“QR”) code. These codes are associated with items. FIG. 4D provides a diagrammatic representation of a user interface when the QR code of an item has been scanned by a buyer's mobile computing device 4. In this instance, the user can purchase the item through the wireless communication network accessible via the mobile device 4. Alternatively, the user can place the item on a wish list or watch list, can go to the sale page of the associated sale and view other items, or go directly to the item's page and view more information about the item.

Similarly, FIG. 4E demonstrates an interface of a seller's computing device 30 once the seller has scanned an item's QR code. The seller can then place that item for sale, add that item to the seller's inventory, or view sales records of that item or of other items of the same type that the seller has made in the past.

Other graphical interface screens may be pulled up by the application software to display the user's preferences, including the user's location information, payment information, and history of purchases or sales. Other interface screens may show additional item information such as quantity and condition of the item for sale or additional photographs of the item. This information can be accessed by navigating the menu option and/or digital links within the basic item or sale descriptions themselves.

### III. Customizable Online Sales Platform

Sellers and buyers accessing the sales software or website will be allowed to set up their user accounts. These accounts include several means for personalizing a seller or buyer account, such as customizable avatars and tags identifying the types of goods a buyer or seller is generally interested in.

Additionally, local sales or individual items can be personalized or identified using badges. Different, pre-created badges can be selected by the seller when the sale or item is being created on the website. These badges can later be selected or de-selected at will. These badges include descriptions and notifications to potential buyers such as “buy one get one free,” “rare item,” or a discount percentage (e.g. “10%,” “20%,” etc.).

It is to be understood that the invention can be embodied in various forms, and is not to be limited to the examples discussed above. The range of components and configurations which can be utilized in the practice of the present invention is virtually unlimited.

Having thus described the invention, what is claimed as new and desired to be secured by Letters Patent is:

1. A computer-based sales system, the system comprising:
a computer network allowing wireless communication among a plurality of computing devices through wireless communications;
a first computing device associated with a buyer, said first computing device including a CPU, data storage, a GNSS antenna and receiver, and a camera, said first computing device being connected to said computer network;
a second computing device associated with a seller, said second computing device including a CPU, data storage, and a camera, said second computing device being connected to said computer network;
a remote server having a CPU and data storage containing a central database, said server being connected to said computer network;
sales association service software stored on said remote server and accessible via said computer network;
a sales location set by said seller, said sales location including an item for sale; and
a request for said item for sale sent by said first computing device and received by said remote server.

2. The system according to claim 1, wherein said seller comprises an entity selected from the list comprising: thrift store, a consignment store, and a yard sale.

3. The system according to claim 1, wherein said item for sale comprises a second-hand item for sale.

4. The system according to claim 1, wherein said item for sale is placed on a watch list using said first computing device.

5. The system according to claim 4, further comprising:
an alert signal sent to said first computing device, wherein said alert is predicated by a change in price of said item for sale; and
wherein said change in price is entered into said second computing device.

6. The system according to claim 4, wherein said watch list is stored on said remote server data storage.

7. The system according to claim 1, wherein said item for sale is identified by a quick response (QR) code readable by said first computing device and said second computing device.

8. The system according to claim 1, wherein said item for sale is identified by a bar code readable by said first computing device and said second computing device.

9. A computer-implemented method of advertising goods for sale, comprising the steps:
registering a buyer with a sales association service, wherein said sales association service comprises a remote server with a CPU and data storage containing a central database storing sales association service software, said server being connected to a computer network, and wherein said seller is associated with a first computing device having a CPU, data storage, a GNSS antenna and receiver, and a camera, said first computing device being connected to said computer network;
registering a seller with said sales association service, said seller associated with a second computing device associated with a seller, said second computing device including a CPU, data storage, and a camera, said second computing device being connected to said computer network;
said seller creating a sales event with said second computing device, said sales event comprising an event date and an item for sale;
said buyer performing a search of said central database with said first computing device; and
notifying said buyer of said sales event.

10. The computer-implemented method according to claim 9, further comprising the steps:
locating said item for sail using said first computing device; and
placing said item for sale on a digital watch list, said item for sale including a first price.

11. The computer-implemented method according to claim 10, further comprising the steps:
altering said item for sale by changing said first price to a second price using said second computing device; and
sending an alert to said first computing device indicating the second price.

12. The computer-implemented method according to claim 9, further comprising the steps:
associating said item for sale with a QR code;
scanning said QR code with said second computing device; and
transferring item data from said second computing device to said central database, wherein said item data is stored within said QR code.

13. The computer-implemented method according to claim 12, further comprising the steps:
scanning said QR code with said first computing device; and
receiving said item data with said first computing device.

14. The computer-implemented method according to claim 13, further comprising the step:
placing said item for sale on a digital watch list, said item for sale including a first price.

15. The computer-implemented method according to claim 13, further comprising the step:
purchasing said item for sale with said first computing device, wherein funds are digitally transferred from a buyer's account registered with said first computing device to a seller's account registered with said second computing device.

16. The computer-implemented method according to claim 9, further comprising the steps:
associating said item for sale with a bar code;
scanning said bar code with said second computing device; and
transferring item data from said second computing device to said central database, wherein said item data is stored within said bar code.

17. The computer-implemented method according to claim 16, further comprising the steps:
scanning said bar code with said first computing device; and
receiving said item data with said first computing device.

18. The computer-implemented method according to claim 17, further comprising the step:
placing said item for sale on a digital watch list, said item for sale including a first price.

19. The computer-implemented method according to claim 17, further comprising the step:
purchasing said item for sale with said first computing device, wherein funds are digitally transferred from a buyer's account registered with said first computing device to a seller's account registered with said second computing device.
